(19) United States
(12) Patent Application Publication
(10) Pub. No.: US 2023/0354770 A1
(43) Pub. Date: Nov. 9, 2023

(54) FARROWING PEN FOR A GROUP FARROWING PEN, AND RESPECTIVE GROUP FARROWING PEN

(71) Applicant: BIG DUTCHMAN INTERNATIONAL GMBH, Vechta (DE)

(72) Inventors: Andre Appel, Friesoythe (DE); Daniel Behrens, Ganderkese (DE); Stefan Gaeckle, Twistringen (DE); Birgit Hinrichs, Vechta (DE)

(73) Assignee: BIG DUTCHMAN INTERNATIONAL GMBH, Vechta (DE)

(21) Appl. No.: 18/143,290

(22) Filed: May 4, 2023

(30) Foreign Application Priority Data
May 6, 2022 (LU) 502037

(51) Int. Cl. A01K 1/02

(52) U.S. Cl. CPC A01K 1/0218

(57) ABSTRACT

A farrowing pen for a group farrowing pen arranged in the farrowing pen includes a piglet protection device having a first side part, a second side part, which is arranged substantially parallel to the first side part and is spaced apart therefrom in such a manner that the first and the second side part laterally delimit a receiving space for a sow, and a rear-side door element movable between a closed position and an open position, which, in the closed position, delimits the receiving space on the rear side and, in the open position, opens up a rear-side access to the receiving space.

The farrowing pen designed such that the sow can automatically enter and/or leave the receiving space of the piglet-protection device, with the rear-side door element being transferred by the sow into the closed position if the sow has entered the piglet-protection device.

### CROSS-REFERENCE TO FOREIGN PRIORITY APPLICATION

The present application claims the benefit under 35 U.S.C. §§ 119(b), 119(e), 120, and/or 365(c) and which claims priority to Application No. LU502037 filed May 6, 2022.

### FIELD OF THE INVENTION

The invention relates to a farrowing pen for a group farrowing pen with a piglet-protection device arranged in the farrowing pen, wherein the piglet-protection device comprises a first side part, a second side part, which is arranged substantially parallel to the first side part and is spaced apart therefrom in such a manner that the first and the second side part laterally delimit a receiving space for a sow, and a rear-side door element which is movable into a closed position and into an open position and which, in the closed position, delimits the receiving space on the rear side and, in the open position, opens up a rear-side access to the receiving space.

### BACKGROUND OF THE INVENTION

Such farrowing pens, also referred to as the nesting box, with a piglet-protection device are known from the prior art. Piglet-protection devices are used, in particular in pig breeding, to support the mother animal, also referred to as sow, during the birth process. The birth process, in the case of pigs, is also referred to as farrowing. Piglet-protection devices furthermore serve the purpose of protecting new-born piglets from mechanical action, in particular entrapment, by the sow.

Farrowing pens which have a piglet-protection cage which is formed by side parts and further add-on parts and which defines a receiving space for the sow and which is accessible via a door element, which is generally arranged on the rear side, are known from the prior art. Such piglet-protection devices are known, for example, from DE 20 2021 002 592 U1 and DE 20 2016 006 889 U1 or else EP 2 698 059 B1. In the case of such known farrowing pens, the rear-side door element of the piglet-protection device is manually closed or opened by an operator. Furthermore, traditional mating pens with a self-catching function are known, for example the LD-Box from ACO FUNKI.

Although the cited prior art has basically proven successful, there is nevertheless room for improvement. In particular, when farrowing pens are used with piglet-protection devices, it has been shown in an overall view with group farrowing pens that, in the situation in which a sow enters the piglet-protection device or farrowing pen via the open rear door, further sows which are located in a movement space of the group farrowing pen occasionally show curious or territorial behaviour to the effect that they enter into contact or interaction with the sow which has entered the piglet-protection device, and this may signify undesirable stress and anxiety for the sow which has entered the piglet-protection device. In order to avoid this, door elements have to be opened or closed manually, but this has proven complicated.

Furthermore, self-catching systems are also known in which the door is locked after the sow has entered. However, a disadvantageous effect in this case is that it is not possible for the sow to only temporarily enter the piglet-protection device since the door is locked after it has entered. If, in other words, the sow has moved into the piglet-protection device, a sow can no longer exit from it under its own power.

### SUMMARY OF THE INVENTION

Against this background, the object on which the invention is based was to develop a farrowing pen of the type mentioned at the beginning to the effect that the disadvantages previously found in the prior art are eliminated as far as possible. In particular, a farrowing pen was to be specified which permits the sow to remain within the farrowing pen or piglet-protection device undisturbed and determined by the sow, with the intention being for manual operating activities by personnel to be very substantially dispensed with.

According to the invention, the object is achieved in the case of a farrowing pen of the type mentioned at the beginning in that the farrowing pen is designed such that the sow can automatically enter and/or leave the receiving space of the piglet-protection device, with the rear-side door element being transferred by the sow into the closed position if the sow has entered the piglet-protection device.

In this way, the closed rear-side door element prevents further animals who are in the region of a movement space of the group farrowing pen, causing distress to or disturbing the sow located in the piglet-protection device. At the same time, in the event that the rear-side door element is not locked, the sow can leave the piglet-protection device if it chooses.

The arrangement according to the invention furthermore affords the advantage that working protection of the operating personnel is improved and at the same time fewer manual activities are required because the sow no longer has to be secured manually. Furthermore, the sow can have a litter of piglets and suckle them without disturbance in the piglet-protection device, the piglet-protection device serving in a manner known per se as a protective barrier against an inadvertent mechanical action on the piglets by the sow.

The invention is developed by the fact that the rear-side door element in the open position extends in the direction of a movement space arranged adjacent to the piglet-protection device, wherein a protection device, in particular a guard bracket, is arranged adjacent to the open position of the rear-side door element. This protection device or guard bracket prevents the rear-side door element from being inadvertently shut in the open state by sows in the movement region. Furthermore, the protection device provides mechanical protection for piglets located in the movement space.

Preferably, the piglet-protection device furthermore comprises a locking device which can be brought into a movement position and into a catch position, wherein the locking device locks the rear-side door element in the catch position after a sow has entered the receiving space, and the rear-side door element can be opened in the movement position by the sow located in the receiving space. In this way, it is both permitted for the sow to be able to move freely into the piglet-protection device and out of the latter if the locking device is in the movement position, or else for the sow to be kept in the piglet-protection device after entering the piglet-protection device, by blocking of the rear-side door elements. The effect achieved by this is that the piglet-protection device can be used for a multiplicity of scenarios and the effort by operating personnel is reduced. In other words, it is possible both for the sow to be allowed free movement and it can also be achieved without manual intervention that the sow to a certain extent traps itself in the piglet-protection device if it is desired.

According to a preferred embodiment, the farrowing pen has a piglet-movement space, designed in particular in the manner of a piglet nest, which is formed adjacent to at least one side part of the piglet-protection device, in particular adjacent to both side parts of the piglet-protection device. Such a farrowing pen is also referred to as a nesting box. The piglet-movement space serves as a retreat area for the piglets. It is thereby ensured that, during the birth phase, the piglet movement space or the piglet nest is arranged adjacent to the sow such that the sow can be directly in contact with the piglets. Furthermore, in the birth period and in the days in which the sow is secured in the piglet-protection device, the piglets also have short paths between the sow's udder and the piglet nest, which has proven to promote health.

Also, the effect achieved by the directly adjacent arrangement of the piglet-movement space or piglet nest to the piglet-protection device in which the sow is located is that direct body contact with the sow can be produced, and, furthermore, it is avoided that piglets get lost or cool down. The piglet nest is kept free from soiling by the sow since the latter, when secured in the piglet-protection device, has no possibility of dispensing excrement in the region of the piglet nest or the piglet nests. This affords the advantage for the operating personnel that piglet treatments are facilitated when the sow is secured in the piglet-protection device and the piglets are located in the piglet movement spaces. Piglets can easily be caught and gripped because of this limited movement region.

Preferably, an actuating element is arranged in the region of the receiving space, said actuating element being designed to be brought from a closed position into an open position by a sow entering the receiving space, wherein the actuating element is coupled to the rear-side door element by means of a coupling device in such a manner that a movement of the actuating element brings about a movement of the rear-side door element, and vice versa, wherein the coupling is designed in such a manner that the open position of the rear-side door element corresponds to the closed door position of the actuating element and the closed position of the rear-side door element corresponds to the open position of the actuating element. By coupling the rear-side door element by means of a coupling device to an actuating element which is operated to a certain extent by a sow entering the piglet-protection device, the rear-side door element is closed after the sow has entered the piglet-protection device and the associated actuation of the actuating element.

By the sow pressing against the rear-side door element, the actuating element is simultaneously brought again into a closed position such that, when a sow re-enters the piglet-protection device, the rear-side door element can be closed again. This affords the advantage for the operating staff, that manual closing and opening of doors is dispensed with. The term “open position” means here that an actuating element or door element is not in the way of the sow in the region of the receiving space. The term “closed position” means that the actuating element or door element is in the way of the sow in the region of the receiving space and can optionally be actuated by said sow.

The invention is developed in that the rear-side door element is a first rear-side door element, and wherein the piglet-protection device has a second rear-side door element which is arranged adjacent to the first rear-side door element and is movable into a closed position and into an open position, wherein the first and the second rear-side door element in the closed position together delimit the receiving space on the rear side and in the open position open up the rear-side access to the receiving space, wherein the actuating element is a first actuating element and the piglet-protection device has a second actuating element which is arranged in the region of the receiving space and is likewise designed to be brought from a closed position into an open position by a sow entering the receiving space, wherein the second actuating element is coupled to the second rear-side door element by means of a second coupling device in such a manner that a movement of the second actuating element brings about a movement of the second rear-side door element, and vice versa, wherein the coupling is designed in such a manner that the open position of the second rear-side door element corresponds to a closed position of the second actuating element and the closed position of the second rear-side door element corresponds to the open position of the second actuating element. The effect achieved by using two actuating elements and two rear-side door elements is that the movement region or pivoting region of the door elements and actuating elements turns out to be smaller than in solutions with just one door element. In this way, the installation space of the piglet-protection device can be reduced and, furthermore, the forces which are required for actuating the door elements and are to be applied by the entering or exiting sow can be reduced.

According to a preferred embodiment, the second actuating element is arranged adjacent to the first actuating element. It is thereby ensured that the actuating elements and the rear-side door elements are actuated substantially uniformly and simultaneously when the sow enters into contact with the actuating elements.

According to a preferred embodiment, the first actuating element is designed as a first actuating door element which, in the open position, runs substantially parallel to the first side part and, in a closed position, projects in particular substantially at a right angle to the first side part into the receiving space, and/or wherein the second actuating element is designed as a second actuating door element which, in the open position, runs substantially parallel to the second side part and, in a closed position, projects in particular substantially at a right angle to the second side part into the receiving space. The effect achieved in this way is that the actuating elements which are designed as actuating door elements can be actuated in a simple manner by the sow, for example, by the shoulder region thereof. Furthermore, after entry of the sow, the actuating door elements, by being actuated by the sow, run substantially parallel to the side parts, and therefore they do not have a disturbing effect either for the sow itself or for the piglets and operating personnel.

The invention is furthermore developed in that the first coupling device and/or the second coupling device has a connecting element which connects the actuating door element to the rear-side door element. The connecting element can be designed, for example, as a rod which is connected to the respective door elements. An extension arm to which the connecting element is rotatably connected is preferably attached to the respective door element. The door elements are preferably arranged adjacent to the side parts or alternatively connected directly thereto via joints.

The farrowing pen is developed in that the latter has, in particular, a rectangular, enclosure which is interrupted by the at least one rear-side door element of the piglet-protection device, and wherein access to the farrowing pen is provided or blocked via the at least one rear-side door element of the piglet-protection device. In this way, not only can the sow leave the piglet-protection device and therefore the farrowing pen via the one or the two rear-side door elements, but also, when the door elements are open, so too can the piglets located in the farrowing pen.

According to an alternatively preferred embodiment, a rear piglet-movement space is formed behind the piglet-protection device, wherein bottom sides of the rear-side door elements are spaced apart from a floor of the farrowing pen in such a manner that the sow is held securely in the piglet-protection device and piglets can change below the rear-side door elements into the rear piglet-movement space. This alternatively preferred embodiment is based on the finding that it has occasionally been observed in practice that piglets inside the piglet-protection device between the sow and the rear-side door elements become distressed. Providing a rear piglet-movement space, into which the piglets can change at any time because of the spacing of the rear-side door elements from the floor, reliably prevents this.

The invention is developed in that the rear-side door elements in the open position extend into the rear piglet-movement space. This avoids sows which are in the movement space from inadvertently encountering the rear-side door elements. The use of protection devices projecting into the movement space, for example, guard brackets, can therefore also be dispensed with. Preferably, the rear piglet-movement space is connected to the first piglet-movement space and to the second piglet-movement space in such a manner that piglets can change from the rear piglet-movement space into the first and second piglet-movement spaces, and vice versa. In this way, the piglets can move around the sow on at least three sides.

According to a preferred embodiment, the bottom sides of the rear-side door elements are spaced apart by 15 cm to 20 cm in a vertical direction from the floor of the farrowing pen. Such a distance range has proven particularly suitable to ensure that the sow is held reliably in the piglet-protection device and at the same time piglets can change under the rear-side door elements into the rear piglet-movement space.

According to a preferred embodiment, a separating element is arranged between the rear piglet-movement space and a movement space adjacent to the farrowing pen, said separating element being dimensioned in such a manner that the sow can climb over the separating element and the piglets are kept within the farrowing pen. The separating element preferably has a height of 15 cm to 20 cm. This prevents the piglets from leaving the farrowing pen in the direction of a movement space, but at the same time makes it possible for the sow to climb over the separating element.

The separating element preferably has a height of 15 cm to 20 cm. The separating element is preferably rounded on its top side, with in particular a tube being arranged on the top side of the separating element. This minimises the risk of injury for the sows. The separating element is received exchangeably in a vertical guide. In this way, it is also possible, for example, to provide a separating element with a greater height for an individual farrowing pen if, for example, sows are located in the movement space, and therefore it is possible for an individual farrowing pen to avoid sows entering the region of the rear piglet-movement space.

The invention is developed in that a door element, in particular a piglet gate, is arranged adjacent to the movement space in the enclosure of farrowing pen, said door element in an open state permitting the piglets to pass out of the farrowing pen into an adjacent movement space. In this way, the piglets can easily be provided with access from the farrowing pen to the movement space.

According to a preferred embodiment, the first and the second side parts are arranged in a fixed position, in particular in the manner of a piglet-protection cage. According to an alternatively preferred embodiment, the piglet-protection device has a trough console on an end side lying opposite the rear-side door elements, wherein the actuating door elements are arranged adjacent to the trough console in such a manner that a sow moves the actuating door elements into the open position, in particular with a shoulder region, when the sow approaches the trough console. Preferably, the first side part and/or the second side part are/is designed as a grid-like side part. Furthermore, it is preferred that the first and/or the second side part have/has a piglet deflector.

According to a preferred development, a first piglet-movement space is assigned a first heating means and a second piglet-movement space is assigned a second heating means, wherein the heating means are designed and configured in such a manner that they heat the piglet-movement spaces to different temperatures. In other words, for example, two different climate zones can be created on the right and left of the sow, for example, by floor heating, coverings, and lamps, and therefore the piglets can select their respective feel-good area.

In a further aspect, the invention relates to a group farrowing pen with at least two farrowing pens arranged adjacent to one another and with a movement space arranged adjacent to the farrowing pens. The invention achieves the object referred to at the beginning with respect to the group farrowing pen by at least one of the farrowing pens, in particular all of the farrowing pens, being designed according to one of the preceding exemplary embodiments. The group farrowing pen makes use of the same advantages and preferred embodiments as the piglet-protection device according to the invention and the farrowing pen according to the invention. In this regard, reference is made to the above embodiments and the content thereof is hereby incorporated.

A series of further advantages are achieved by the configuration according to the invention of the group farrowing pen. If, for example, a sow and piglets are located in a farrowing pen and, by release of the rear-side door element, what is referred to as a movement phase is enabled, the respective sows and piglets can then use the common movement space. To this extent, the sows can walk several steps in one direction in the movement space, with the movement radius overall being significantly increased in comparison to solutions previously known from the prior art. The sows can also correspondingly turn around and move away from heat sources frequently arranged in the farrowing pens, and therefore the sensation of comfort for the animals can be increased.

Before the actual birth process, it is furthermore possible for several sows to get to know one another in the region of the movement space. After the farrowing, the sows then do not have to conduct any or fewer hierarchical fights if piglets are additionally also located in the movement space. Furthermore, the sows are spared transport stress from the transport that is required in devices previously known from the prior art a few days after the farrowing. For the personnel, driving processes which are frequently required in the devices previously known from the prior art for enabling social behaviour between the sows are dispensed with. Furthermore, during the birth phase or the treatment phase, the movement space can act simultaneously as a control passage. The movement space therefore has a dual use. Furthermore, the advantage is afforded that, in the event of discharges being planned from the group farrowing pen, only one access to the outside is necessary and this access can be used by sows from a multiplicity of farrowing pens. Even farrowing pens located far away from a stall outer wall can therefore be connected to a single outlet.

The invention is developed in that a plurality, in particular, all of the farrowing pens have the locking devices according to the above exemplary embodiment, wherein the locking devices are actuable via a common actuating means. A plurality of piglet-protection devices can thus be jointly provided in the movement or catch mode. In contrast to systems previously known from the prior art, no doors or side parts of each individual pen have to be actuated.

### BRIEF DESCRIPTION OF THE DRAWINGS

The invention is described in more detail below using preferred exemplary embodiments with reference to the attached Figures, in which:

FIG. 1 shows an exemplary embodiment of a group farrowing pen according to the invention with two farrowing pens and piglet-protection devices arranged therein, in a perspective illustration;

FIGS. 2 and 3 show enlarged illustrations of details of the group farrowing pen according to the invention according to FIG. 1 from different perspectives;

FIG. 4 shows a group farrowing pen with eight farrowing pens in a top view;

FIG. 5 shows an alternative exemplary embodiment of a farrowing pen in a top view; and

FIG. 6 shows a region of the farrowing pen according to FIG. 5 in a perspective illustration.

### DETAILED DESCRIPTION OF THE EMBODIMENTS

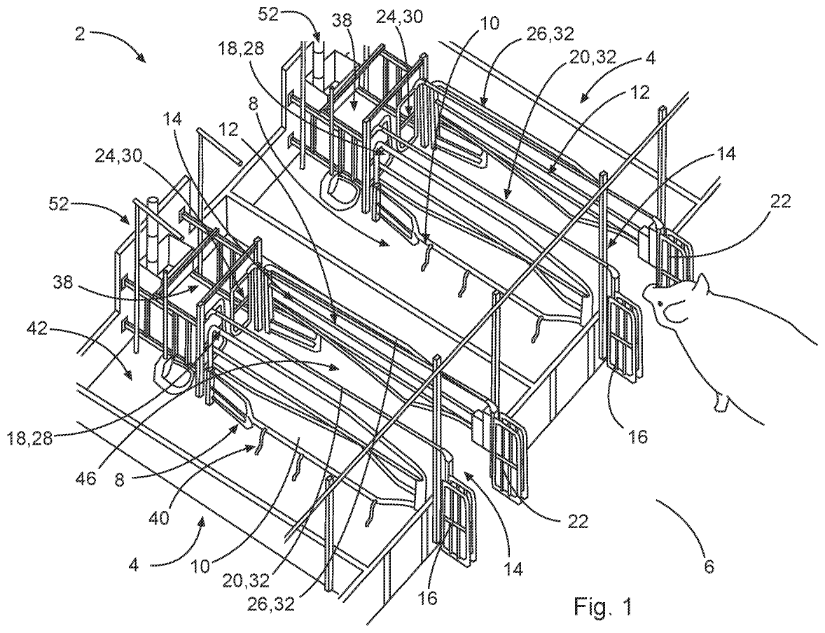

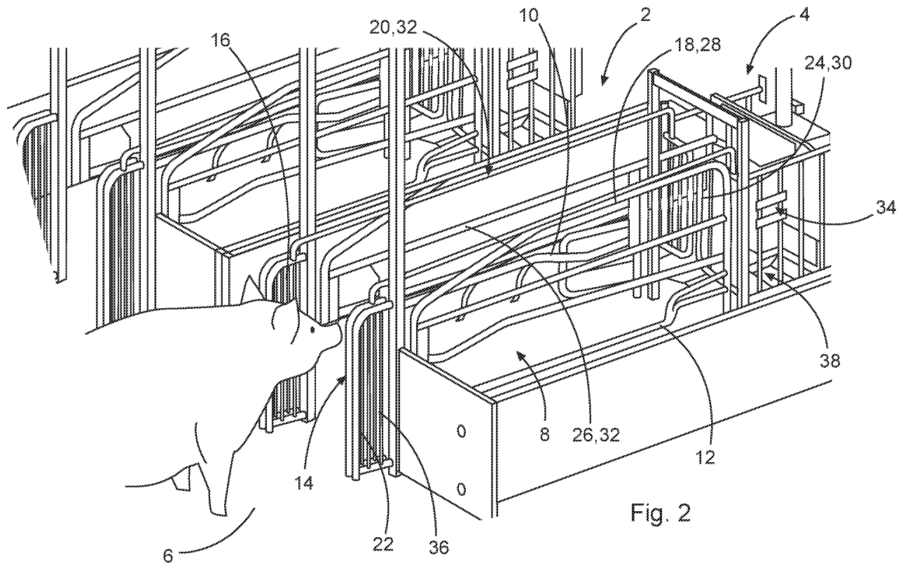

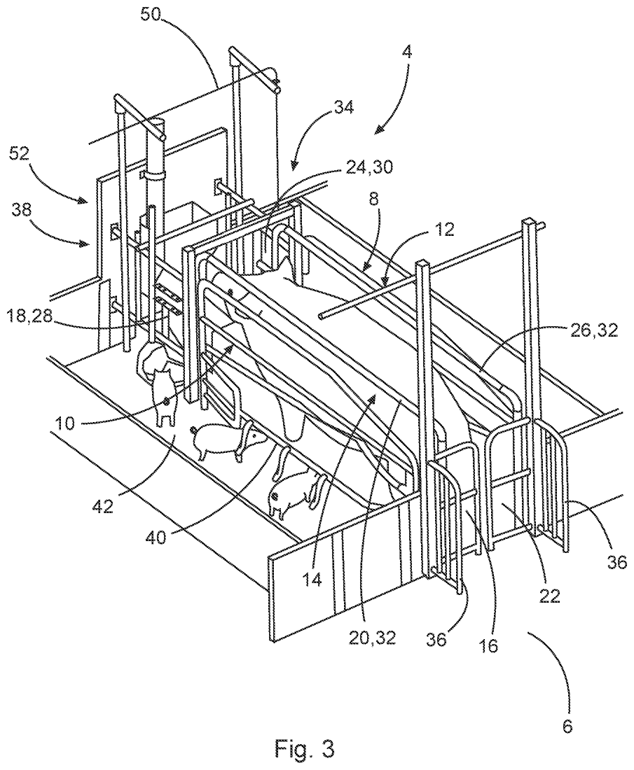

FIGS. 1 to 3 show a group farrowing pen 2. In the illustration according to FIGS. 1 to 3, the group farrowing pen 2 has two farrowing pens 4 arranged adjacent to one another. A movement space 6 is arranged adjacent to the farrowing pens 4. The farrowing pen 4 has a rectangular enclosure. The enclosure is interrupted by rear-side door elements 16, 22 of a piglet-protection device 8. Access to the farrowing pen 4 from the movement space 6 is provided via the rear-side door elements 16, 22 of the piglet-protection device 8 (as shown in FIGS. 1 and 2) or blocked (as shown for example in FIG. 3).

The piglet-protection device 8 has a first side part 10 and a second side part 12. The first side part 10 is arranged substantially parallel to the second side part 12 and is spaced apart from the latter in such a manner that the first and the second side part 10, 12 laterally delimit a receiving space for a sow. The rear-side door elements 16, 22 are movable into a closed position and into an open position. In the closed position, the rear-side door elements 16, 22 delimit the receiving space 14 on the rear side. In the open position, the rear-side door elements 16, 22 open up rear-side access to the receiving space 14.

The piglet-protection device 8 has an actuating element 18. The actuating element 18 is designed to be brought into an open position by a sow entering the receiving space 14, as illustrated in FIG. 3. The actuating element 18 is coupled to the rear-side door element 16 by means of a coupling device 20. The coupling is designed in such a manner that movement of the actuating element 18 brings about movement of the rear-side door element 16, and vice versa. The open position of the rear-side door element 16 here corresponds to the closed position of the actuating element 18 and the closed position of the rear-side door element 16 to the open position of the actuating element 18. The second rear-side door element 22 is arranged adjacent to the first rear-side door element 16 and is likewise movable into a closed position and into an open position.

In the closed position, the first and the second rear-side door element 16, 22 jointly delimit the receiving space 14 on the rear side and, in the open position, open up the rear-side access to the receiving space 14. The piglet-protection device 8 has a second actuating element 24. It is likewise designed to be brought into an open position by a sow entering the receiving space 14. The second actuating element 24 is coupled to the second rear-side door element 22 by means of a second coupling device 26 in such a manner that a movement of the second actuating element 24 brings about a movement of the second rear-side door element 22, and vice versa. The coupling is designed in such a manner that the open position of the second rear-side door element 22 corresponds to the closed position of the second actuating element 24 and the closed position of the second rear-side door element 22 corresponds to the open position of the second actuating element 24.

The second actuating element 24 is arranged adjacent to the first actuating element 18. In particular, the first actuating element 18 is designed as a first actuating door element 28. The first actuating door element 28 runs substantially parallel to the first side part 10 in the open position and, in a closed position, runs in particular substantially at a right angle to the first side part 10. The open position of the first actuating door element 28 is shown in FIGS. 1 and 2, and the closed position in FIG. 3.

Furthermore, the second actuating element 24 is also designed as a second actuating door element 30. In the open position (cf. FIG. 3), the second actuating door element 30 runs substantially parallel to the second side part 12 and, in a closed position (cf. FIGS. 1 and 2), runs in particular substantially at a right angle to the second side part 12. In the closed position, the first actuating door element 28 and the second actuating door element 30 project into the receiving space 14. The first coupling device 20 and the second coupling device 26 each have a connecting element 32 which connects the respective actuating door element 28, 30 to the respective rear-side door element 16, 22.

The piglet-protection device 8 furthermore has a locking device 34 which can be seen in FIGS. 2 and 3. The locking device 34 can be brought into a movement position and into a catch position. The locking device 34 locks the rear-side door element 16, 22 in the catch position after a sow has entered the receiving space 14. In the movement position, the rear-side door elements 16, 22 can be automatically opened by the sow located in the receiving space 14. In the open position, the rear-side door elements 16, 22 extend in the direction of the movement space 6 arranged adjacent to the piglet-protection device 8. A respective protection device 36 which is designed in particular as a guard bracket is formed adjacent to the open position of the respective rear-side door elements 16, 22. This prevents sows which are located in the movement space 6 from inadvertently closing the rear-side door elements 16, 22.

The first side part 10 and the second side part 12 are arranged in a fixed position. The rear-side door elements 16, 22 are arranged directly adjacent to the side parts 10, 12 or are connected directly thereto. The piglet-protection device 8 furthermore has a trough console 38 on an end side 56 opposite the rear-side door elements 16, 22. The actuating door elements 28, 30 are arranged adjacent to the trough console 38 in such a manner that a sow moves the actuating door elements 28, 30 into the open position, in particular with a shoulder region of the sow, when the sow approaches the trough console 38 within the receiving space 14. The first side part 10 and the second side part 12 are designed as grid-like side parts 10, 12. Furthermore, the first side part 10 and the second side part 12 have a piglet deflector 40. A respective piglet-movement space 42, 46 configured in the manner of a piglet nest is formed adjacent to the side parts 10, 12 of the piglet-protection device 8. As shown in particular in FIGS. 2 and 3, the locking devices 34 of the two farrowing pens 4 are actuable via a common actuating means 50. In this way, for example, the two piglet protection devices 8 can be jointly brought into the catch position or the movement position by a single actuating means 50.

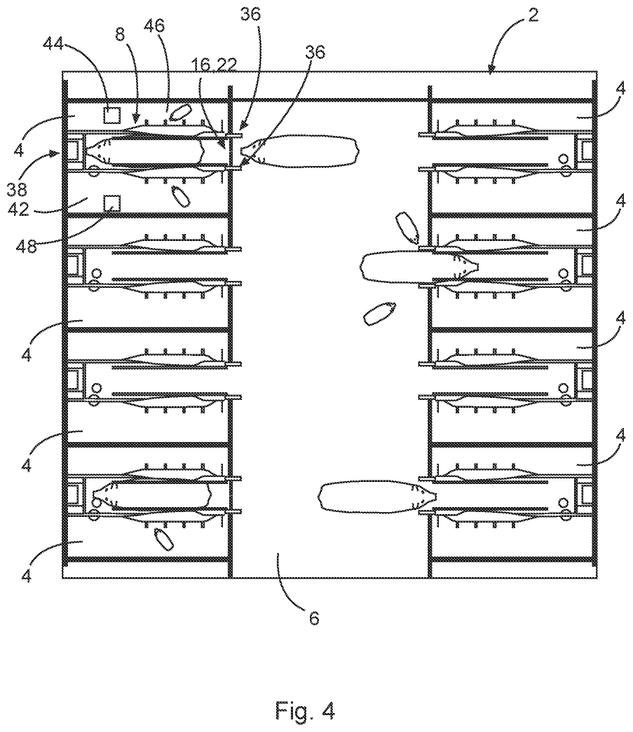

FIG. 4 shows a top view of a group farrowing pen 2. The group farrowing pen 2 has a total of eight farrowing pens 4, of which in each case four farrowing pens 4 are arranged adjacent to one another. A movement space 6 which is accessible from all of the farrowing pens 4 is provided between the respective four adjacently arranged farrowing pens 4. Each of the farrowing pens 4 has a piglet-protection device 8 described with reference to FIGS. 1 to 3.

As can be seen with reference to the farrowing pen 4 illustrated at the top left, the farrowing pen 4 has piglet-movement spaces 42, 46 on both sides of the piglet-protection device 8. Illustrated by way of example, the first piglet-movement space 42 has a first heating means 44. The second piglet-movement space 46 has a second heating means 48. If the first piglet-movement space 42 is heated by means of the heating means 44, 48 to a temperature differing from the temperature of the second piglet-movement space 46, two climate zones can be formed, and therefore the piglets can select their feel-good area.

As can likewise be seen from FIG. 4 with reference to the farrowing pen illustrated at the top left, the entry of the sow into the piglet-protection device 8 has caused the rear-side door elements 16, 22 to be closed, as a result of which a disturbance by the second sow which is residing immediately adjacent to the farrowing pen 4 and is illustrated in the upper region is avoided. When the rear-side door elements 16, 22 are open, the protection devices 36 which are designed in particular as brackets prevent an undesired or inadvertent closing of said door elements by contact with a sow located in the movement space 6.

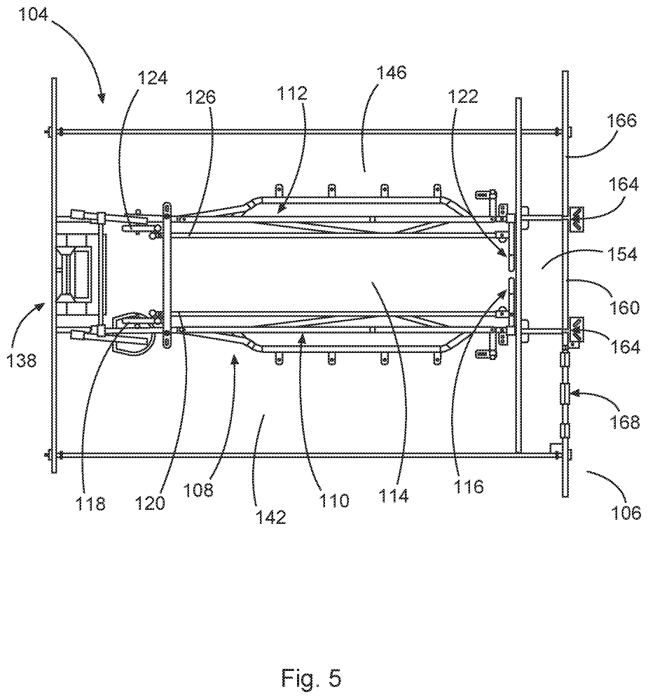

FIG. 5 shows an alternative exemplary embodiment of a farrowing pen 104. The farrowing pen 104 is arranged adjacent to a movement space 106. The farrowing pen 104 has a piglet-protection device 108. The piglet-protection device 108 has a first side part 110, a second side part 112 and rear-side door elements 116, 122 which define a receiving space 114 for a sow (not shown). As already described with reference to FIGS. 1 to 4, the rear-side door elements 116, 122 are coupled to actuating elements 118, 124 via coupling devices 120, 126 in such a manner that a sow entering the piglet-protection device 108 closes the rear-side door elements 116, 122 by actuating the actuating elements 118, 124. A pressure console 138 is arranged adjacent to the actuating elements 118, 124. A first piglet-movement space 142 and a second piglet-movement space 146 are located laterally adjacent to the piglet-protection device 108. Furthermore, a rear piglet-movement space 154 is formed behind the piglet-protection device 108.

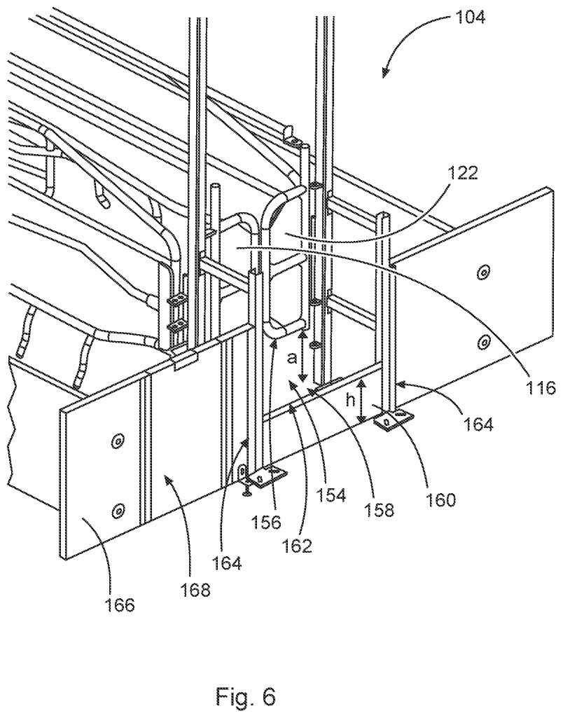

As can also be seen in particular with reference to FIG. 6, the undersides 156 of the rear-side door element 116, 122 is spaced apart from a floor 158 of the farrowing pen 104 in such a manner that the sow is held securely in the piglet-protection device 108 and the piglets can change below the rear-side door elements 116, 122 into the rear piglet-movement space 154. In the open position, the rear-side door elements 116, 122 extend into the rear piglet-movement space 154. The rear piglet-movement space 154 is connected to the first piglet movement space 142 and to the second piglet-movement space 146 in such a manner that piglets can change from the rear piglet-movement space 154 into the first and second piglet-movement spaces 142, 146, and vice versa.

The bottom sides 156 of the rear-side door elements 116, 122 are spaced apart by 15 cm to 20 cm from the floor 158 of the farrowing pen 104 in a vertical direction. A separating element 160 is arranged between the rear piglet-movement space 154 and a movement space 106 adjacent to the farrowing pen 104. The separating element 160 is dimensioned in such a manner that the sow can climb over the separating element 160 and the piglets are kept within the farrowing pen 104. The separating element 160 can optionally be replaced by a separating element of greater height such that the farrowing pen 104 is shielded from animals located in the movement space 106. Such a separating element of greater height can be completely removed if the sow is to leave the farrowing pen 104. The piglets can then also change into the movement space 106. The separating element 160 has a height h of 15 cm to 20 cm. 106 The separating element 160 is rounded in its top side 162, with a tube (not illustrated) in particular being arranged on the top side of the separating element 160. The separating element 160 is received exchangeably in a vertical guide 164.

The enclosure 166 of the farrowing pen 104 has a door element 168, in particular a piglet gate 168, adjacent to the movement space 106, the piglet gate 168 in an open state, which is achieved in particular by lifting the piglet gate 168 or guiding the piglet gate 168 upward, permitting transfer of the piglets from the farrowing pen 104 into an adjacent movement space 106.

1.-23. (canceled)

24. A farrowing pen for a group farrowing pen with a piglet-protection device arranged in the farrowing pen, wherein the piglet-protection device comprises:
a first side part;
a second side part, which is arranged substantially parallel to the first side part and is spaced apart therefrom in such a manner that the first and the second side part laterally delimit a receiving space for a sow; and
a rear-side door element which is movable between a closed position and an open position and which, in the closed position, delimits the receiving space on a rear side and, in the open position, opens a rear-side access to the receiving space;
wherein the farrowing pen is adapted to allow the sow to automatically enter and/or leave the receiving space of the piglet-protection device, with the rear-side door element being transferred by the sow into the closed position if the sow has entered the piglet-protection device.

25. The farrowing pen according to claim 24, wherein the rear-side door element in the open position extends in the direction of a movement space arranged adjacent to the piglet-protection device; and
wherein a protection device is disposed adjacent to the open position of the rear-side door element.

26. The farrowing pen according to claim 24, further comprising:
a locking device having a movement position and a catch position, wherein the locking device locks the rear-side door element in the catch position after a sow has entered the receiving space, and the rear-side door element can be opened in the movement position by the sow located in the receiving space.

27. The farrowing pen according to claim 24, wherein a piglet-movement space is formed adjacent to at least the first side part, the second side part, or both the first side part and the second side part of the piglet-protection device.

28. The farrowing pen according to claim 24, wherein an actuating element is arranged in the region of the receiving space, the actuating element being adapted to be brought from a closed position into an open position by a sow entering the receiving space;
wherein the actuating element is coupled to the rear-side door element by means of a coupling device such that a movement of the actuating element brings about a movement of the rear-side door element, and vice versa; and
wherein the coupling device is adapted such that the open position of the rear-side door element corresponds to a closed position of the actuating element and the closed position of the rear-side door element corresponds to the open position of the actuating element.

29. The farrowing pen according to claim 28, wherein the rear-side door element is a first rear-side door element, and wherein the piglet-protection device has a second rear-side door element which is arranged adjacent to the first rear-side door element and is movable between a closed position and an open position,
wherein the first and the second rear-side door element in the closed position together delimit the receiving space on the rear side and in the open position open the rear-side access to the receiving space;
wherein the actuating element is a first actuating element and the piglet-protection device has a second actuating element which is arranged in the region of the receiving space and is likewise designed to be brought from a closed position into an open position by a sow entering the receiving space;
wherein the second actuating element is coupled to the second rear-side door element by means of a second coupling device such that a movement of the second actuating element brings about a movement of the second rear-side door element, and vice versa, wherein the second coupling device is adapted such that the open position of the second rear-side door element corresponds to the closed position of the second actuating element and the closed position of the second rear-side door element corresponds to the open position of the second actuating element; and
wherein the second actuating element is arranged adjacent to the first actuating element.

30. The farrowing pen according to claim 29, wherein the first actuating element is adapted as a first actuating door element which, in an open position, runs substantially parallel to the first side part and, in a closed position, projects substantially at a right angle to the first side part into the receiving space, and/or wherein the second actuating element is adapted as a second actuating door element which, in an open position, runs substantially parallel to the second side part and, in a closed position, projects substantially at a right angle to the second side part into the receiving space.

31. The farrowing pen according to claim 29, wherein the first coupling device and/or the second coupling device has a connecting element which connects the first and/or second actuating door element to the first and/or second rear-side door element.

32. The farrowing pen according to claim 24, wherein the farrowing pen has an enclosure which is interrupted by the rear-side door element of the piglet-protection device, and wherein access to the farrowing pen is provided or blocked via rear-side door element of the piglet-protection device.

33. The farrowing pen according to claim 27, wherein a rear piglet-movement space is formed behind the piglet-protection device; and
wherein bottom side of the rear-side door element is spaced apart from a floor of the farrowing pen such that the sow is held securely in the piglet-protection device and piglets can change below the rear-side door element into the rear piglet-movement space.

34. The farrowing pen according to claim 33, wherein the rear-side door element in the open position extend into the rear piglet-movement space, and/or wherein the rear piglet-movement space is connected to a first piglet-movement space and to a second piglet-movement space in such a manner that piglets can change from the rear piglet-movement space into the first and second piglet-movement spaces, and vice versa.

35. The arrowing pen according to claim 34, wherein the bottom side of the rear-side door element is at a distance of 15 cm to 20 cm from the floor of the farrowing pen in a vertical direction.

36. The farrowing pen according to claim 34, wherein a separating element is arranged between the rear piglet-movement space and a movement space adjacent to the farrowing pen, said separating element being dimensioned in such a manner that the sow can climb over the separating element and the piglets are kept within the farrowing pen.

37. The farrowing pen according to claim 36, wherein the separating element has a vertical height of 15 cm to 20 cm, and/or wherein the separating element is rounded on its top side.

38. The farrowing pen according to claim 36, wherein the separating element is received exchangeably in a vertical guide.

39. The farrowing pen according to claim 24, wherein a piglet gate is arranged adjacent to a movement space in the enclosure of the farrowing pen, said piglet gate in an open state permitting the piglets to pass out of the farrowing pen into an adjacent movement space.

40. The farrowing pen according to claim 24, wherein the first and the second side parts are arranged in a fixed position.

41. The farrowing pen according to claim 30, wherein the piglet-protection device has a trough console on an end side lying opposite the rear-side door element, wherein the first and second actuating door elements are arranged adjacent to the trough console such that a sow moves the first and second actuating door elements into the open position when the sow approaches the trough console.

42. The farrowing pen according to claim 24, wherein the first side part and/or the second side part are/is designed as a grid-like side part.

43. The farrowing pen according to claim 24, wherein the first and/or the second side part have/has a piglet deflector.

44. The farrowing pen according to claim 24, wherein a first piglet-movement space is assigned a first heating means and a second piglet-movement space is assigned a second heating means, and wherein the first and second heating means are adapted to heat the first and second piglet-movement spaces, respectively, to different temperatures.

45. At least two farrowing pens for a group farrowing pen with a piglet-protection device arranged in the farrowing pen, wherein the piglet-protection device comprises:
a first side part;
a second side part, which is arranged substantially parallel to the first side part and is spaced apart therefrom in such a manner that the first and the second side part laterally delimit a receiving space for a sow; and
a rear-side door element which is movable between a closed position and an open position and which, in the closed position, delimits the receiving space on a rear side and, in the open position, opens a rear-side access to the receiving space; and
wherein the farrowing pen is adapted to allow the sow to automatically enter and/or leave the receiving space of the piglet-protection device, with the rear-side door element being transferred by the sow into the closed position if the sow has entered the piglet-protection device; and
wherein the at least two farrowing pens are arranged adjacent to one another and with a movement space arranged adjacent to the at least two farrowing pens.

46. A plurality of farrowing pens for a group farrowing pen with a piglet-protection device arranged in the farrowing pen, wherein the piglet-protection device comprises:
a first side part;
a second side part, which is arranged substantially parallel to the first side part and is spaced apart therefrom in such a manner that the first and the second side part laterally delimit a receiving space for a sow;
a rear-side door element which is movable between a closed position and an open position and which, in the closed position, delimits the receiving space on a rear side and, in the open position, opens a rear-side access to the receiving space; and
a locking device having a movement position and a catch position, wherein the locking device locks the rear-side door element in the catch position after a sow has entered the receiving space, and the rear-side door element can be opened in the movement position by the sow located in the receiving space;
wherein the farrowing pen is adapted to allow the sow to automatically enter and/or leave the receiving space of the piglet-protection device, with the rear-side door element being transferred by the sow into the closed position if the sow has entered the piglet-protection device; and
wherein the locking devices of the plurality of the farrowing pens are adapted for simultaneous actuation.
